(19) United States
(12) Patent Application Publication
(10) Pub. No.: US 2026/0260012 A1
(43) Pub. Date: Sep. 3, 2026

(54) System and Method for Persistent On-Device Conversational Memory with Secure Transfer and Local Ethical Context Enforcement

(71) Applicant: Jonathan Harada, Emmaus, PA (US)

(72) Inventor: Jonathan Harada, Emmaus, PA (US)

(21) Appl. No.: 19/182,746

(22) Filed: Apr. 18, 2025

(51) Int. Cl. G06F 21/62; G06F 16/22; G06F 21/60

(52) U.S. Cl. CPC G06F 21/6227; G06F 16/22; G06F 21/602

(57) ABSTRACT

This invention provides a system and method for enabling AI-driven persistent memory stored directly on user devices, without reliance on cloud infrastructure. The method allows a conversational AI to recall prior user interactions across sessions, maintain ethical boundaries locally, and function across device restarts, enhancing privacy, continuity, and contextual awareness. Memory is stored using user ID, role, message, and timestamp, creating a modular, evolvable architecture. Secure transfer and enforcement protocols allow license-based deployment and compliance in high-sensitivity applications, including defense, healthcare, education, and financial systems.

### BACKGROUND

Existing AI systems are predominantly cloud-based, stateless, and contextually limited. Most require internet connections, offer no persistent memory across sessions, and compromise user privacy. Prior art lacks a modular, locally stored AI memory system that maintains ethical constraints and identity recall without server-side infrastructure. This invention addresses those limitations by providing a fully local, secure, and license-controlled AI memory structure.

### SUMMARY OF THE INVENTION

The disclosed invention stores and retrieves user conversations on-device using a four-field structure: userId, role, message, and timestamp. These are used to reconstruct past conversation threads, enabling the AI to maintain memory and context. Memory is saved in a local database (e.g., SQLite), with optional encryption and user-specific access control. The architecture supports local ethical enforcement protocols and modular deployment, allowing secure use in sectors requiring confidentiality and compliance, such as defense, healthcare, education, and financial systems.

### DETAILED DESCRIPTION

The invention relates to a system and method that allows AI assistants to maintain memory of past user interactions on-device. The system writes interaction data to a local persistent store, such as a SQLite database, using fields for user ID, role (user or AI), message text, and timestamp. This enables the assistant to maintain long-term memory, replicate human-like memory continuity, and adhere to ethical recall protocols.

Unlike cloud-dependent models, this structure functions fully offline and does not require data transmission to external servers. Optional internet connectivity may be used for non-essential features, such as updates or cross-device synchronization, without compromising core local memory functionality. Optional encryption ensures secure handling of data. The AI uses stored memory to rehydrate its personality and prior context, achieving continuity, increased personalization, and ethical response enforcement without centralized processing.

1. A method for implementing persistent conversational memory on a user device, comprising: storing AI interaction data locally on the device using a database; the stored data including a user identifier, interaction role, message content, and timestamp;
retrieving said stored data to provide memory continuity across sessions.

2. The method of claim 1, wherein the AI system operates without a continuous internet connection.

3. The method of claim 1, wherein the memory is used to recall past user-AI interactions and influence future AI responses contextually.

4. The method of claim 1, further comprising secure encryption of the local database using device-specific credentials.

5. The method of claim 1, wherein an ethical boundary enforcement module resides on the device and governs response generation using stored context.

6. The method of claim 1, further comprising license-based memory synchronization between approved devices under a registered user profile.
